(19) United States
(12) Patent Application Publication
(10) Pub. No.: US 2019/0267864 A1
(43) Pub. Date: Aug. 29, 2019

(54) MOTOR

(71) Applicant: SHINANO KENSHI KABUSHIKI KAISHA, Nagano (JP)

(72) Inventor: Yusuke MURAOKA, Nagano (JP)

(21) Appl. No.: 16/244,654

(22) Filed: Jan. 10, 2019

(30) Foreign Application Priority Data
Feb. 28, 2018 (JP) 2018-034392

(51) Int. Cl. H02K 5/167; H02K 5/08

(52) U.S. Cl. CPC H02K 5/1677; H02K 5/225; H02K 5/08

(57) ABSTRACT

There is provided a motor with improved durability by suppressing the generation of sludge and preventing the decline in function of a sliding bearing. A plurality of spacers 9a, 9b and 9c are provided so as to be stacked in an axial direction between a sliding bearing 8 and an end surface of a rotor 1, and a space 10 is constantly formed between an end surface of the sliding bearing 8 assembled to a shaft hole 5c of a bracket 5 and the spacer 9c facing the end surface.

### CROSS-REFERENCE TO RELATED APPLICATION

This application is based upon and claims the benefit of priority of the prior Japanese Patent Application No. 2018-034392, filed on Feb. 28, 2018, and the entire contents of which are incorporated herein by reference.

### TECHNICAL FIELD

The present invention relates to a motor used for a drive source of, for example, OA equipment, industrial machinery, medical equipment, vehicles, aircrafts, ships, space satellites and the like.

### BACKGROUND ART

In related art, a motor using a sliding bearing (an oil retaining bearing, a sintered bearing or the like) rotatably supporting a rotor shaft performs adjustment of power in a thrust direction through a spacer formed of resin, metal or rubber between a rotor in which the rotor shaft is integrated with a magnetic body or a non-magnetic body and an end surface of the sliding bearing.

For example, FIG. 3A shows a cross-sectional view in an axial direction of an inner-rotor type hybrid stepping motor as an example. FIGS. 3B and 3C are enlarged views of a part P and a part Q of FIG. 3A. In a rotor 51, a rotor core 53 is integrally assembled to a rotor shaft 52. The rotor core 53 is formed by stacking magnetic plates 53b on both sides in the axial direction of a permanent magnet plate 53a. The rotor shaft 52 is rotatably supported by a pair of brackets 55 to which a stator 54 is assembled. Specifically, the rotor shaft 52 is rotatably supported by sliding bearings 56 (oil retaining bearings, sintered bearings and the like) press-fitted to shaft holes 55a provided in the brackets 55. The stator 54 is supported so that a stator core 54a is sandwiched between the pair of brackets 55. Plural pole teeth are provided to protrude toward a radial direction inner side in the stator core 54a, which are arranged so as to face the rotor core 53. The stator core 54a is covered with an insulator 54b, and windings 54c are wound around the pole teeth. The sliding bearings 56 may be assembled to a motor case or a bearing holder (a bearing housing or the like) provided in a motor base, not limited to the pair of brackets 55.

Spacers 57 are provided between the rotor core 53 and the sliding bearings 56. As shown in enlarged views of FIGS. 3B and 3C, a first spacer 57a, a second spacer 57b and a third spacer 57c are provided to be stacked on the rotor core 53 in the rotor shaft 52. Clearances “s” are respectively provided between the third spacers 7c and end surfaces of the sliding bearings 56 arranged so as to face the third spacers 7c in the axial direction.

Furthermore, an end plate formed of a resin washer is provided as a spacer for avoiding contact between the sliding bearing and the rotor core when the rotor shaft moves in the axial direction in a case where a load acts on an output shaft of the motor (refer to FIG. 1 of paragraph 0023 in Specification of PTL 1: JP-A-2001-112212)

### SUMMARY OF INVENTION

### Technical Problem

As shown by an arrow in FIG. 4A, the rotor shaft 52 moves to an output side (left side of FIG. 4A) when a thrust load acts on the rotor 51. At this time, the third spacer 57c on the output side is pushed onto an end surface 56a of the sliding bearing 56 as shown in FIG. 4B, and the clearance “s” between the third spacer 57c on an anti-output side (right side of FIG. 4A) and an end surface 56a of the sliding bearing 56 is increased as shown in FIG. 4C. As described above, the third spacer 57c rotates while being pushed onto the sliding bearing 56 as shown in FIG. 4B and the end plate rotates while being pushed onto the sliding bearing according to PTL 1. As a result, friction occurs between the end surface of the sliding bearing and the spacer. Due to the friction, the bearing formed of sintered metal is worn out and powder (metal powder, resin powder and mixture of them) is generated, then, the powder enters the inside of the bearing to thereby generate mixture of powder and oil (sludge).

A space inside the sliding bearing is filled with the sludge and oil does not circulate inside and outside the bearing, then, the oil between the bearing and the rotor shaft runs out, and the sliding bearing and the rotor shaft rotate in a state of direct metal-to-metal contact to cause a seizure phenomenon, which drastically reduce the lifetime of the sliding bearing. As rotation of the rotor is hindered, durability of the motor is also drastically reduced. In particular, in the case where only one end plate is used as the spacer as described in PTL 1, co-rotation can easily occur when the rotor rotates while being pushed onto the sliding bearing, which encourages the generation of sludge due to friction.

### Solution to Problem

In response to the above issue, one or more aspects of the present invention are directed to a motor with improved durability by suppressing the generation of sludge and preventing the decline in function of the sliding bearing.

Disclosure concerning some embodiments described below includes at least the following configurations.

A motor including a rotor integrally assembled to a rotor shaft and a stator arranged to face the rotor, in which the rotor shaft is rotatably supported by a sliding bearing inserted into a bearing holder, which has a plurality of spacers provided so as to be stacked in an axial direction between the sliding bearing and an end surface of the rotor and a space portion constantly formed between an end surface of the sliding bearing assembled to a shaft hole of the bearing holder and a spacer facing the end surface.

According to the above configuration, the space portion is constantly formed between the end surface of the sliding bearing assembled to the shaft hole of the bearing holder and the spacer facing the end surface even when a thrust load acts on the rotor shaft, therefore, the spacer does not contact the end surface of the sliding bearing. Accordingly, the durability of the motor can be improved by suppressing the generation of sludge and preventing the decline in function of the sliding bearing.

It is preferable that outer diameters of the sliding bearing assembled to the shaft hole of the bearing holder and the spacer abutting on the bearing holder when the thrust load acts thereon are formed to be larger than a diameter of the shaft hole. Accordingly, if the thrust load acts on the rotor shaft, the spacer abuts on a facing wall surface of the bearing holder but does not contact the sliding bearing provided inside the shaft hole, therefore, the generation of sludge can be suppressed.

It is preferable that the sliding bearing is fitted to the shaft hole of the bearing holder so as to be displaced to an outer side in the axial direction from an inner wall surface facing the spacer.

Accordingly, if the spacer abuts on the facing inner wall surface of the bearing holder or the spacer is deformed when the thrust load acts on the rotor shaft, the sliding bearing is provided inside the shaft hole so as to be displaced to the outer side in the axial direction from the inner wall surface of the bearing holder, therefore, the spacer portion is surely interposed and the sliding bearing does not contact the spacer. Therefore, it is possible to positively suppress the generation of sludge and prevent the decline in function of the sliding bearing.

It is preferable that the plural spacers includes a first spacer arranged to abut on the rotor, a second spacer assembled to be stacked on the first spacer and a third spacer assembled to be stacked on the second spacer and arranged to face the inner wall surface of the bearing holder, and an outer diameter of the third spacer is larger than the diameter of the shaft hole.

When the third spacer is provided so as to be stacked over the first spacer for protecting the rotor and the second spacer as a buffer material, co-rotation of the first spacer with respect to the rotor is reduced. The third spacer has a larger diameter than the diameter of the shaft hole provided in the bearing holder, therefore, if the third spacer is pushed onto the facing wall surface of the bearing holder due to the thrust load, the third spacer does not contact the sliding bearing and co-rotation of the third spacer is also reduced, the generation of sludge can be suppressed.

In a case where a resin plate material, a metal plate material, or a composite plate material obtained by combining the above materials is used for the first spacer to the third spacer, the generation of sludge due to friction can be suppressed if the thrust load acts on the rotor shaft and the third spacer formed of any of the resin plate material, the metal plate material, or the composite plate material obtained by combining the above materials is pushed onto the facing inner wall surface of the bearing holder made of metal.

It is preferable that, when a plate thickness of the spacer is “t”, t≥0.2P−0.1 is satisfied with respect to variation in a thrust load P. Accordingly, the durability can be maintained when the spacer with a minimum plate thickness “tm” necessary for the magnitude of the thrust load P is used.

It is preferable that, when a hole diameter of the shaft hole is “q”, an outer diameter of the spacer is “D”, a contact diameter in which the spacer contacts the inner wall surface of the bearing holder is D−q, and the plate thickness of the spacer is “t”, D≥q is satisfied in a case where the thrust load P is 1 kg or less, and D≥15t²+3.5t+2.4+q (D>q) is satisfied in a case where the thrust load is more than 1 kg and 2 kg or less. Accordingly, the durability can be maintained when the spacer with a minimum outer diameter size necessary for a spacer with a prescribed plate thickness “t” with respect to the magnitude of the thrust load P is used.

### Advantageous Effects of Invention

According to the above-described motor, it is possible to improve the durability by suppressing the generation of sludge and preventing the decline in function of the sliding bearing.

### BRIEF DESCRIPTION OF DRAWINGS

FIGS. 1A to 1C are a cross-sectional view in an axial direction and enlarged cross-sectional views in a state where a thrust load does not act on a motor.

FIGS. 2A to 2C are a cross-sectional view in the axial direction and enlarged cross-sectional views in a state where the thrust load acts on the motor.

FIGS. 3A to 3C are a cross-sectional view in the axial direction and enlarged cross-sectional views in a state where the thrust load does not act on a related-art motor.

FIGS. 4A to 4C are cross-sectional view in the axial direction and enlarged cross-sectional views in a state where the thrust load acts on the related-art motor.

FIG. 5 is an explanatory view of a simulation model for checking the relation between a contact diameter D−q in which a third spacer made of resin contacts an inner wall surface of an output-side bracket and the maximum stress which is tolerable when a thrust load P acts.

FIG. 6 is a graph view showing the relation between the contact diameter D−q of the third spacer with a plate thickness t=0.3 (mm) and the maximum stress for each thrust load (kg).

FIG. 7 is a graph view showing the relation between the contact diameter D−q of a third spacer with a plate thickness t=0.4 (mm) and the maximum stress for each thrust load (kg).

FIG. 8 is a graph view showing the relation between the contact diameter D−q of a third spacer with a plate thickness t=0.5 (mm) and the maximum stress for each thrust load (kg).

FIG. 9 is a graph view showing the relation between the minimum plate thickness “tm” (mm) of the third spacer with respect to the thrust load P (kg).

FIG. 10 is a graph view showing the relation between the contact diameter D−q (mm) of the third spacer with respect to the output-side bracket and the plate thickness “t” (mm) of the third spacer in the thrust load P (kg) of 1 kg or more and 2 kg or less.

### DESCRIPTION OF EMBODIMENTS

Hereinafter, a motor according to an embodiment of the present invention will be explained with reference to the drawings.

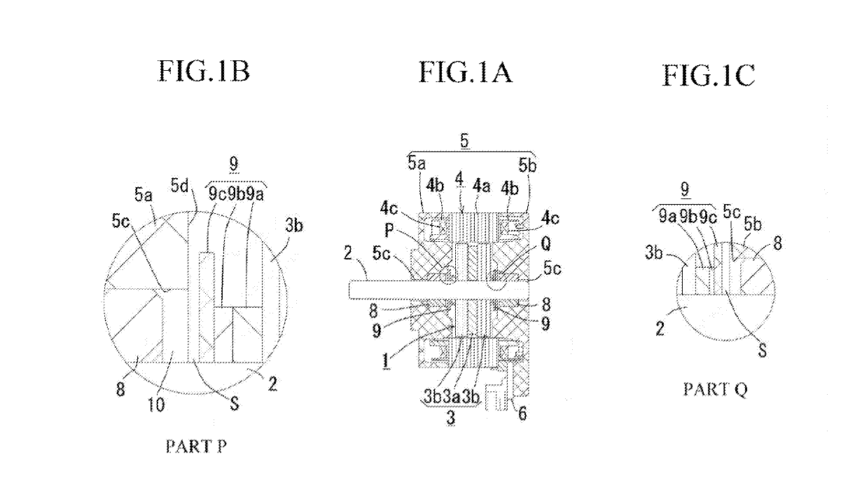

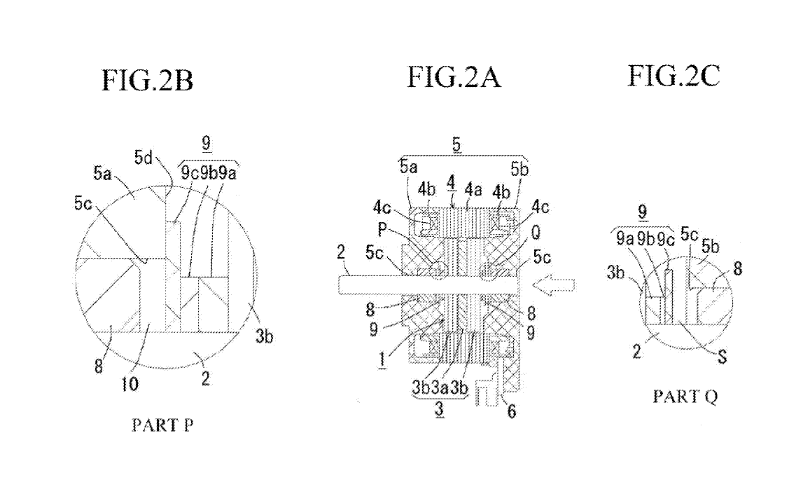

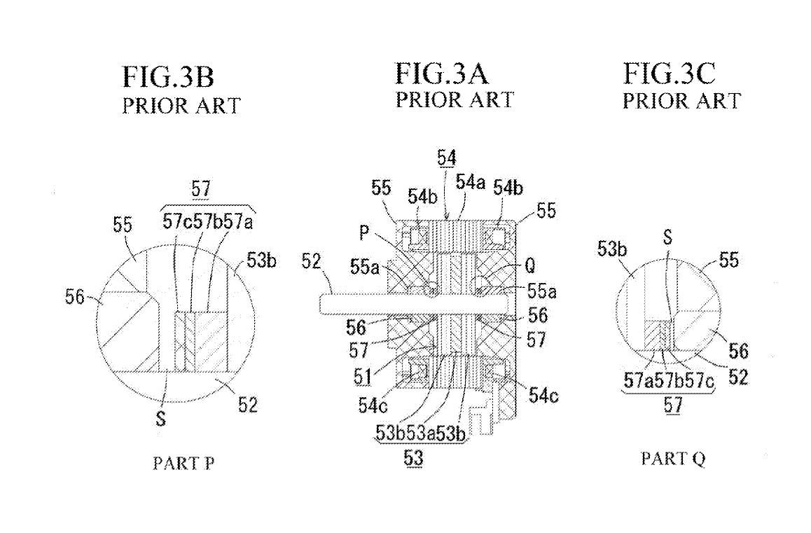

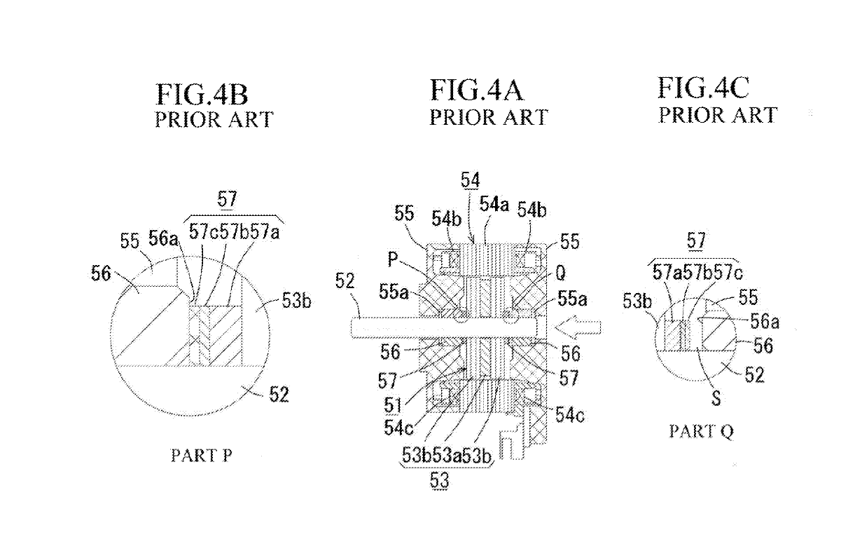

First, a schematic configuration of the motor will be explained with reference to FIGS. 1A to 1C and FIGS. 2A to 2C.

As the motor, for example, an inner-rotor type motor is used, and a hybrid stepping motor is cited as an example to be explained. In FIG. 1A, a rotor core 3 is integrally assembled to a rotor shaft 2 in a rotor 1. The rotor core 3 has a structure in which magnetic plates 3 are respectively stacked on both ends in an axial direction of a permanent magnetic plate 3a. A stator 4 is arranged around the rotor core 3 so as to face the rotor core 3. The stator 4 is supported and fixed in the axial direction by a pair of brackets 5 (for example, metal brackets made of aluminum: bearing holders) arranged in the axial direction. An end portion on an output side (left end portion in FIG. 1A) of the rotor shaft 2 is provided to protrude from an output-side bracket 5a in the axial direction.

The stator 4 has a stator core 4a in which pole teeth are formed toward a radial direction inner side, an insulator 4b and windings 4c wound therearound. A substrate 6 is fixed to a bracket 5b on an anti-output side (right side in FIG. 1A) of the pair of brackets 5, to which coil leads drawn out from the windings 4c are connected.

In the rotor 1, the rotor shaft 2 is rotatably supported by sliding bearings (oil retaining bearings, sintered bearings and the like) 8 respectively inserted into shaft holes 5c provided in the pair of bracket 5. A porous material made of sintered metal is used for the sliding bearings 8 and lubricating oil circulates in gaps inside the bearings and in the outside of the bearings, thereby reducing friction with respect to the rotor shaft 2 and rotatably supporting the rotor shaft 2. Respective sliding shafts 8 are press-fitted into the shaft holes 5c of the brackets 5 respectively and fixed thereto.

A plurality of spacers 9 are provided to be stacked in the axial direction between the pair of sliding bearings 8 and end surfaces in the axial direction of the rotor 1. In the above members, a space portion 10 is constantly formed between an end surface of the sliding bearing 8 assembled to the shaft hole 5c of the bracket 5 and a facing spacer 9 (a third spacer 9c) as shown in FIG. 1B. Even when a thrust load acts on the rotor shaft 2, the facing spacer 9 does not contact the end surface of the sliding shaft 8. Accordingly, the generation of sludge is suppressed and the decline in function of the sliding bearing 8 is prevented, thereby improving durability of the motor. It is not always necessary to provide a pair of sliding bearings 8, and the invention can be applied between the bearing and the spacer 9 facing each other in the axial direction in a case of the sliding bearing at one place.

It is preferable that outer diameters of the sliding bearing 8 assembled to the shaft hole 5c of the bracket 5 and the spacer 9 (third spacer 9c) abutting on the bracket 5 are preferably formed to be larger than a diameter of the shaft hole 5c. Accordingly, even when the thrust load acts on the rotor shaft 2 and the spacer 9 abuts on a facing inner wall surface 5d of the bracket 5, the spacer 9 does not contact the sliding bearing 8 provided in the shaft hole 5c, therefore, it is possible to suppress the generation of sludge.

It is preferable that the sliding bearing 8 is fitted to the shaft hole 5c of the output-side bracket 5a so as to be displaced to an outer side in the axial direction from the inner wall surface 5d facing the spacer 9. Accordingly, if the thrust load acts on the rotor shaft 2 and the spacer 9 (third spacer 9c) abuts on the facing inner wall surface 5d of the of the output-side bracket 5a or the spacer 9 (third spacer 9c) is deformed, the sliding bearing 8 is provide inside the shaft hole 5c so as to be displaced to the outer side in the axial direction from the inner wall surface 5d of the output-side bracket 5a, therefore, the space portion 10 is surely interposed and the sliding bearing 8 does not contact the spacer. Therefore, the generation of sludge can be positively suppressed and the decline in function of the sliding bearing 8 can be prevented.

As the plural spacers 9, a first spacer 9a arranged to abut on the rotor 1 (magnetic plate 3b), a second spacer 9b assembled to be stacked on the first spacer 9a and the third spacer 9c assembled to be stacked on the second spacer 9b and arranged so as to face the inner wall surface 5d of the output-side bracket 5 are provided. The outer diameter of the third spacer 9c is preferably larger than the diameter of the shaft hole 5c. The relation in size between the third spacer 9c and the first/second spacers 9a, 9b is not particularly limited.

As the third spacer 9c is provided so as to be stacked over the first spacer 9a for protecting the rotor 1 and the second spacer 9b as a buffer material, it is possible to reduce co-rotation of the first spacer 9a with respect to the rotor 1, and further, the outer diameter of the third spacer 9c is larger than the diameter of the shaft hole 5c provided in the output-side bracket 5a, therefore, even when the thrust load acts on the rotor 1 and the third spacer 9c is pushed onto the facing inner wall surface 5d of the output-side bracket 5a, the spacer 9c does not contact the sliding bearing 8, and further, co-rotation of the third spacer 9c can be suppressed, as a result, the generation of sludge can be suppressed.

A resin plate material, a metal plate material, or a composite plate material obtained by combining the above materials is used for the first spacer 9a to the third spacer 9c. Nylon 6 or the like is used as the resin plate material, and SUS, SECC or the like is used as the metal plate material. As the composite plate material, a mixed metal washer formed by mixing the above resin material and the metal material or the like is used.

Accordingly, if the thrust load acts on the rotor 1 and the third spacer 9c is pushed onto the facing inner wall surface 5d of the output-side bracket 5, the generation of sludge due to friction can be suppressed.

As shown in enlarged views of FIGS. 1B and 1C, in a case where a load does not act on the rotor 1 in the thrust direction, clearances “s” are respectively formed between the third spacers 9c concentrically assembled to the rotor shaft 2 on both end sides of the rotor 1 and inner wall surfaces 5d of the pair of brackets 5 facing each other.

As shown in an enlarged view of FIG. 2B, the rotor shaft 2 moves to the output side (left side in FIG. 2A) as shown by an arrow when the thrust load acts on the rotor 1 in an arrow direction, therefore, the third spacer 9c is pushed onto the inner wall surface 5d of the output-side bracket 5. As shown in an enlarged view of FIG. 2C, the clearance “s” between the inner surface 5d of the anti-output side (right side in FIG. 2A) bracket 5b shown in FIG. 2A and the third spacer 9c is expanded. As the sliding bearing 8 is fitted to the inside of the shaft hole 5c of the output-side bracket 5a at this time, the space portion 10 is surely formed between the sliding bearing 8a and the third spacer 9c.

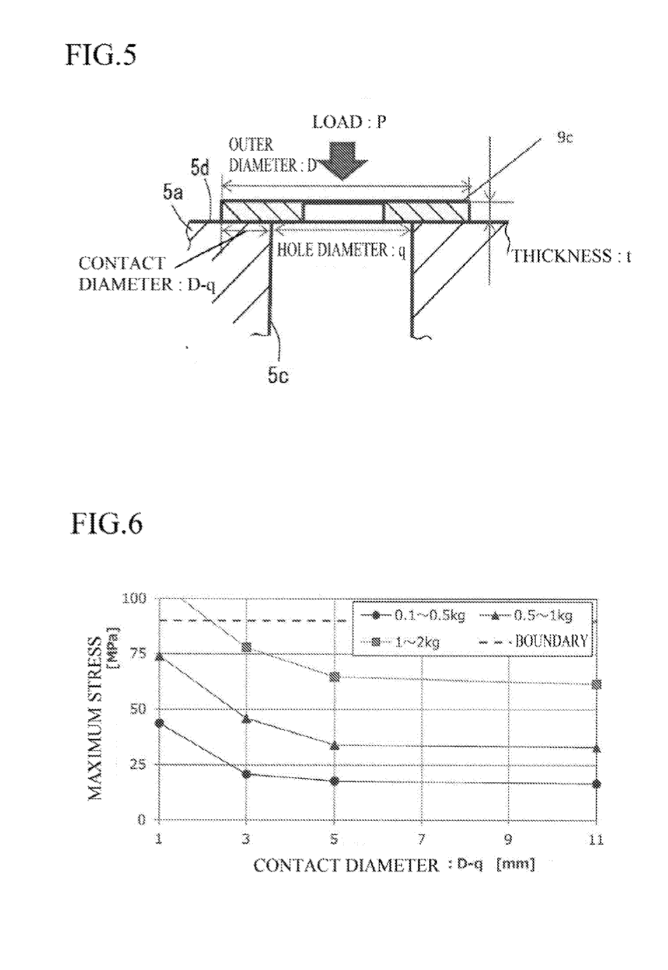

FIG. 5 is an explanatory view of a simulation model for checking the relation between a contact diameter D−q in which the third spacer made of resin contacts the inner wall surface of the output-side bracket and the maximum stress which is tolerable when a thrust load P acts. In FIG. 5, simulations for durability were performed by adding the thrust load P to the third spacer 9c placed and fixed on the inner wall surface 5d of the output-side bracket 5a after being positioned with the shaft hole 5c. As the third spacer 9c, material characteristics (PA6 (nylon 6)) were used. The thrust load P is added to the above-described spacer 9c in a state that rotation in a circumferential direction is stopped.

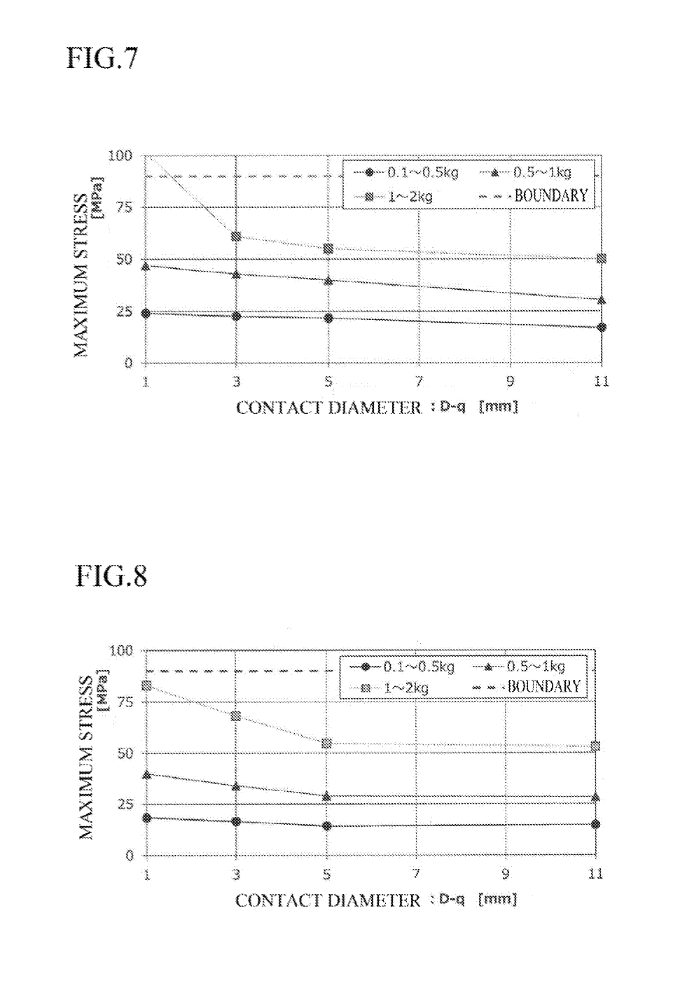

As shown in FIG. 5, the relation between the contact diameter and the maximum stress tolerable were measured by setting a hole diameter of the third spacer 9c to q mm, setting an outer diameter D to ϕq to ϕ20 mm, setting a contact diameter between the third spacer 9c and the inner wall surface 5d the output-side bracket 5a to D−q mm, changing a plate thickness “t” mm to a prescribed value and by gradually changing the thrust load P to 0.1 to 0.5 kg, 0.5 to 1 kg, and 1 kg to 2 kg. In the simulations, the stress acting when the third spacer 9c with a prescribed plate thickness was displaced or deformed in the same direction as the thrust load P was verified. Simulation results are shown in graph views of FIG. 6 to FIG. 8. In respective graph views, a graph line ● represents a case of thrust load=0.1 to 0.5 kg, a graph line ▴ represents a case of thrust load=0.5 to 1 kg and a graph line ▪ represents a case of thrust load=1 to 2 kg. In a case where a sample with a plate thickness “t” of 0.3 mm is used, the material is deformed when the thrust load P is 2 kg and a bending strength of the material exceeds 90 Mpa, therefore, the stress in this case is shown by a broken line as a boundary stress.

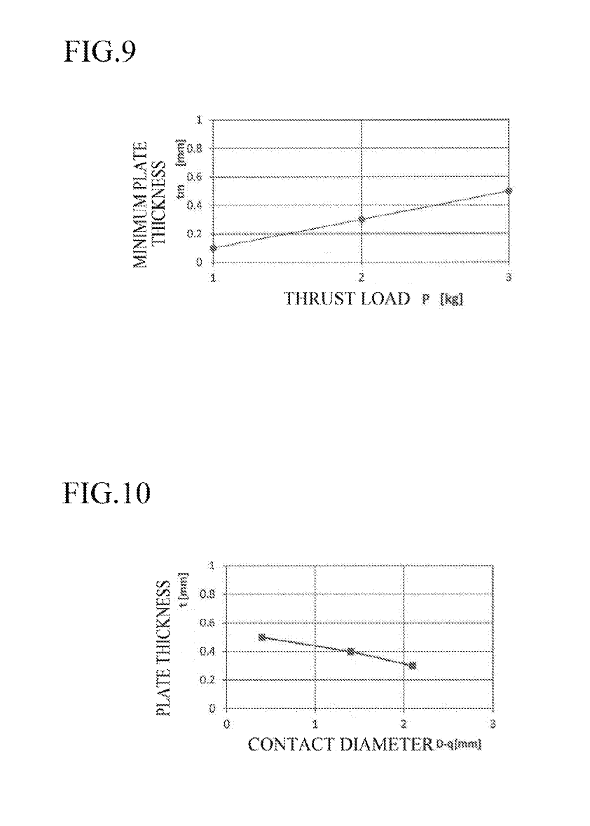

The relation between the minimum plate thickness tm (mm) of the third spacer 9c and the thrust load P (kg) based on the above simulation results is shown by a graph view of FIG. 9. As a result, it is found that the minimum plate thickness “tm” necessary for the third spacer 9c when the thrust load P is changed draws a straight line of tm=0.2P−0.1.

Accordingly, it is found that the third spacer 9c preferably has a thickness “t” that satisfies tm≥0.2P−0.1 with respect to variation in the thrust load P. According to the above, the durability can be maintained when the third spacer 9c with the minimum plate thickness “tm” necessary for the magnitude of the thrust load P is used.

Also, the relation between the contact diameter D−q (mm) between the third spacer 9c with the outer diameter D and the output-side bracket 5a and the plate thickness “t” (mm) of the third spacer 9c based on the simulation results is shown by a graph view of FIG. 10. As a result, it is found that D q is enough as the contact diameter D−q (mm) necessary for the third spacer 9c when the thickness “t” is changed in a case where the thrust load P is 1 kg or less. In a case where the thrust load is more than 1 kg and 2 kg or less, it is found that the contact diameter D−q (mm) necessary for the third spacer 9c when the thickness “t” is changed draws a quadratic curve of D−q=15t²+3.5t+2.4.

Accordingly, it is found that the relation between the outer diameter D and the plate thickness “t” of the third spacer 9c preferably satisfies D≥15t²+3.5t+2.4+q (D>q) with respect to variation in the thrust load P of more than 1 kg and 2 kg or less. Accordingly, the durability can be maintained when the third spacer 9c with the minimum outer diameter size is used as the third spacer 9c with the prescribed plate thickness “t” with respect to the magnitude of the thrust load P.

Though the above embodiment has been explained by using the inner-rotor type hybrid stepping motor as the motor, a normal PM-type or VR-type stepping motor may be used, and further, a brushless motor, a brush motor or the like may also be used.

The sliding bearing 8 may be assembled to a motor case or a bearing holder (a bearing housing or the like) provided in a motor base, not limited to the pair of brackets 5.

What is claimed is:

1. A motor including a rotor integrally assembled to a rotor shaft and a stator arranged to face the rotor, in which the rotor shaft is rotatably supported by a sliding bearing inserted into a bearing holder, comprising:
a plurality of spacers provided so as to be stacked in an axial direction between the sliding bearing and an end surface of the rotor; and
a space portion constantly formed between an end surface of the sliding bearing assembled to a shaft hole of the bearing holder and a spacer facing the end surface.

2. The motor according to claim 1,
wherein outer diameters of the sliding bearing assembled to the shaft hole of the bearing holder and the spacer abutting on the bearing holder when a thrust load acts thereon are formed to be larger than a diameter of the shaft hole.

3. The motor according to claim 1,
wherein the sliding bearing is fitted to the shaft hole of the bearing holder so as to be displaced to an outer side in the axial direction from an inner wall surface facing the spacer.

4. The motor according to claim 1,
wherein the plural spacers includes a first spacer arranged to abut on the rotor, a second spacer assembled to be stacked on the first spacer and a third spacer assembled to be stacked on the second spacer and arranged to face the inner wall surface of the bearing holder, and
an outer diameter of the third spacer is larger than the diameter of the shaft hole.

5. The motor according to claim 4,
wherein a resin plate material, a metal plate material, or a composite plate material obtained by combining the above materials is used for the first spacer to the third spacer.

6. The motor according to claim 1,
wherein, when a plate thickness of the spacer is “t”, t≥0.2P−0.1 is satisfied with respect to variation in a thrust load P.

7. The motor according to claim 1,
wherein, when a hole diameter of the shaft hole is “q”, an outer diameter of the spacer is “D”, a contact diameter in which the spacer contacts the inner wall surface of the bearing holder is D−q, and the plate thickness of the spacer is “t”, D≥q is satisfied in a case where the thrust load P is 1 kg or less, and D≥15t²+3.5t+2.4+q (D>q) is satisfied in a case where the thrust load is more than 1 kg and 2 kg or less.
